(19) United States
(12) Patent Application Publication
(10) Pub. No.: US 2012/0312889 A1
(43) Pub. Date: Dec. 13, 2012

(54) INJECTOR TIP ASSEMBLY AND METHOD OF FUEL INJECTION

(75) Inventors: Natesh Chandrashekar, Sugar Land, TX (US); Dustin Wayne Davis, Marlborough, CT (US); Benjamin Campbell Steinhaus, Missouri City, TX (US); Shashishekara Sitharamarao Talya, Houston, TX (US)

(73) Assignee: GENERAL ELECTRIC COMPANY, Schenectady, NY (US)

(21) Appl. No.: 13/155,578

(22) Filed: Jun. 8, 2011

(51) Int. Cl. F02M 61/00

(52) U.S. Cl. 239/5; 239/533.12

(57) ABSTRACT

An injector tip for a nozzle includes a center body having a plurality of center body openings at a distal end configured to inject a fuel flow into a combustion zone of a combustor. One or more fuel passages are arranged around the center body and are configured to inject a fuel slurry into the combustion zone. One or more oxygen passages are arranged around the center body and are configured to inject an oxygen flow into the combustion zone.

### BACKGROUND OF THE INVENTION

The subject matter disclosed herein relates to gasification and combustors. More particularly, the subject disclosure relates to injector nozzles for gasification.

Many known integrated gasification combined-cycle (IGCC) plants include a gasification system that is integrated with at least one power-producing turbine system. For example, at least some known gasification systems convert a mixture of fuel, air or oxygen, steam, and/or CO₂ into a synthetic gas, or “syngas”. The sysngas is channeled to the combustor of a gas turbine engine, which powers an electrical generator that supplies electrical power to a power grid. Exhaust from at least some known gas turbine engines is supplied to a heat recovery steam generator (HRSG) that generates steam for driving a steam turbine. Power generated by the steam turbine also drives an electrical generator that provides electrical power to the power grid.

At least some gasification systems include an injection system that supplies a gasifier reactor with process fluids to facilitate at least one exothermic reaction. Some gasification systems use multiple types of fuel to drive the gasification process. For example, a coal gasification plant primarily utilizes a coal slurry as fuel to drive gasification which converts the carbon in the coal into a gaseous fuel to produce electricity. When the gasifier is initialized, however, the system components downstream of the gasification chamber are not yet at a design point operating pressure, so the process efficiency is lacking. Thus, gasification of the coal slurry produces a higher amount of undesirable emissions such as sulfur and/or NOₓ until the downstream components are brought up to pressure.

In an attempt to alleviate these emissions issues, cleaner burning fuels, such as natural gas are often introduced into the gasification chamber during startup in place of the coal slurry. The natural gas is injected into the gasifier via a dedicated nozzle separate from that of the coal slurry.

### BRIEF DESCRIPTION OF THE INVENTION

According to one aspect of the invention, an injector tip for a gasifier combustor nozzle includes a center body having a plurality of center body openings at a distal end configured to inject a fuel flow into a combustion zone of the combustor. One or more fuel passages are arranged around the center body and are configured to inject a fuel slurry into the combustion zone. One or more oxygen passages are arranged around the center body and are configured to inject an oxygen flow into the combustion zone.

According to another aspect of the invention, a method of fuel injection into a combustor includes injecting a first portion of a fuel flow into a combustion zone of the combustor through a plurality of center body openings in a distal end of a center body of an injector tip. A second portion of the fuel flow is injected into the combustion zone via one or more fuel passages arranged around the center body. The injection of the second portion of the fuel flow is suspended and a fuel slurry is injected into the combustion zone via one or more fuel passages.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic cross-sectional view of an embodiment of an injector tip for a gasifier nozzle;

FIG. 2 is a schematic of operation of an embodiment of an injector tip for a gasifier nozzle during startup operation; and

FIG. 3 is a schematic of operation of an embodiment of an injector tip for a gasifier nozzle during coal slurry operation.

The detailed description explains embodiments of the invention, together with advantages and features, by way of example with reference to the drawings.

### DETAILED DESCRIPTION OF THE INVENTION

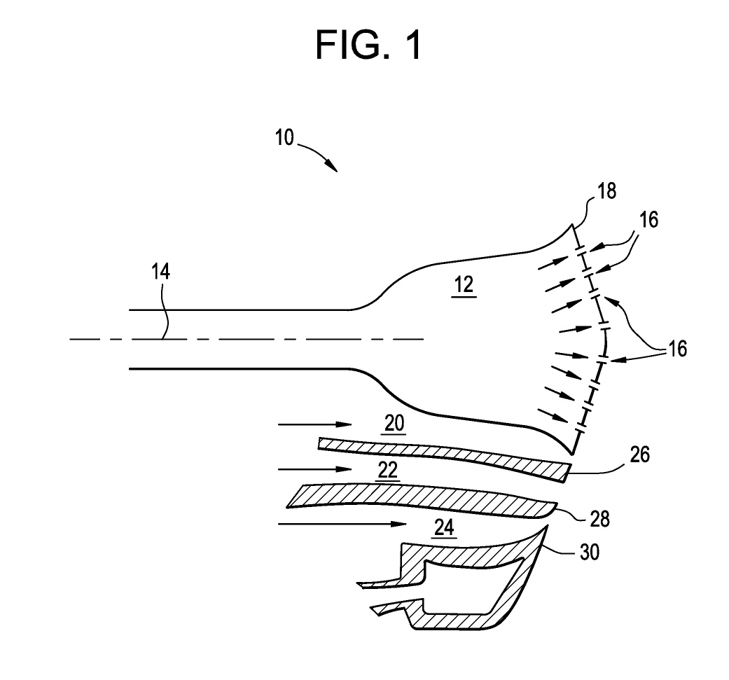

Shown in FIG. 1 is an embodiment of an injection nozzle tip 10 for a gasifier. The nozzle tip 10 of the embodiment of FIG. 1 includes four separate and distinct channels for flow of streams of materials through the nozzle tip 10. First, the nozzle tip 10 includes a center body 12 which is, in some embodiments, located at a central axis 14 of the nozzle tip 10. The center body 12 includes a plurality of center body openings 16 located at a distal end 18 of the center body 12.

A plurality of fuel passages, or lances, are arranged surrounding the center body 12. An inner passage 20 is located around the center body 12, and in some embodiments is concentric with the center body 12. A middle passage 22 is located around the center body 12 outboard of the inner passage 20, and in some embodiments is concentric with the center body 12 and/or the inner passage 20. As shown in FIG. 1, an outer passage 24 is located around the center body 12 outboard of the middle passage 22, and in some embodiments is concentric with the center body 12, the inner passage 20 and/or the middle passage 22. In some embodiments, an inner passage end 26, a middle passage end 28, and/or an outer passage end 30 are flush with the distal end 18 of the center body 12.

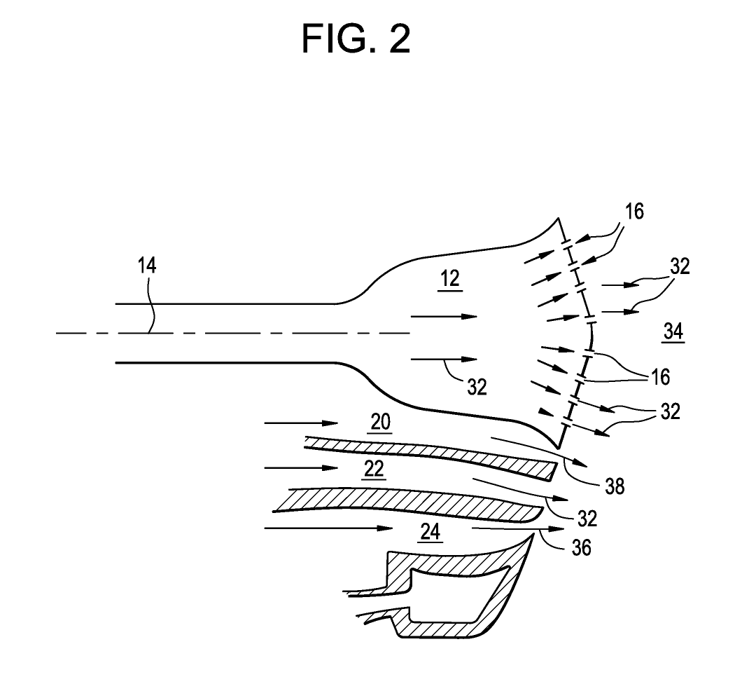

At startup of the gasifier, as shown in FIG. 2, a fuel flow 32, for example, a low-sulfur fuel such as natural gas, is injected into a combustion zone 34 downstream of the nozzle tip 10 through the center body 12 via the center body openings 16. The fuel flow 32 of the low sulfur fuel is also injected into the combustion zone 34 through the middle passage 22. A flow of primary oxygen 36 is provided to the combustion zone 34 through the outer passage 24. The primary oxygen 36 is mixed with the fuel flow 32 in the combustion zone 34 and combusted therein. In some embodiments, a flow of secondary oxygen 38 may be injected into the combustion zone 34 through the inner passage 20 to provide further oxygen for combustion with the fuel flow 32.

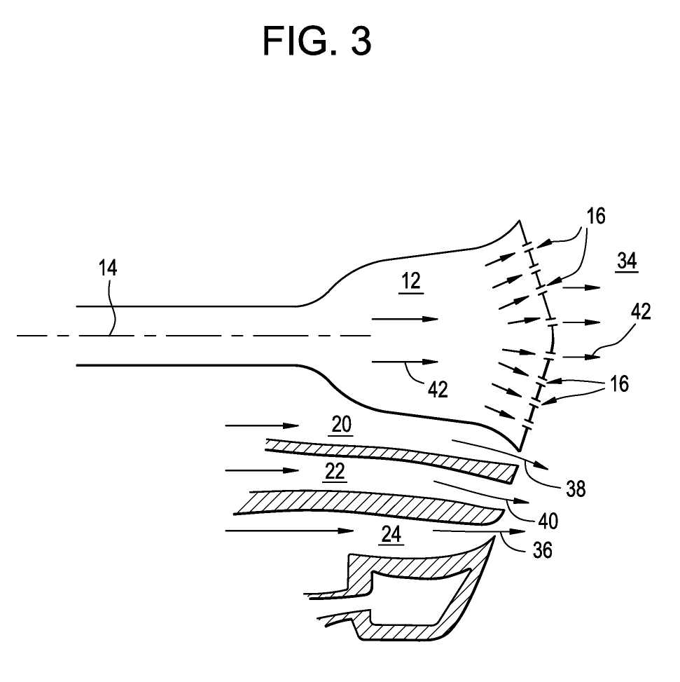

Referring now to FIG. 3, during coal slurry mode operation of the gasifier, middle passage 22 is utilized to convey a flow of gasifier fuel, such as coal slurry 40 into the combustion zone 34. Primary oxygen 36 and secondary oxygen 38 are provided through the outer passage 24 and the inner passage 20, respectively. Since, during normal operation, the flow of coal slurry 40 drives the gasification process, the fuel flow 32 through the center body 12 is stopped, and a flow of a different fluid 42, such as carbon dioxide (which may be recycled), nitrogen, steam, or water, is flowed through the center body openings 16. The fluid 42 can be purge gas, moderator gas or cooling liquid. The fluid 42 provides cooling to the center body 12, and also prevents plugging of the center body openings 16 with particulates from the combustion of the coal slurry 40. Further, the fluid 42 prevents burnbacks, combustion products backing upstream through the center body openings 16, in the center body 12.

During transitions in operation from, for example, startup operation and coal slurry mode operation, both fuel flow 32 and coal slurry 40 may be injected into the combustion zone 34, with the fuel flow 32 injected through the center body openings 16 and the coal slurry 40 injected through the middle passage 22. As the transition occurs from startup (all fuel flow 32) to coal slurry mode (all coal slurry 40), an amount of each flow can be gradually changed to provide a smooth transition between the two modes. For example, as the operation moves from startup to coal slurry mode, the amount of fuel flow 32 injected through the center body openings 16 is gradually decreased while the amount of coal slurry 40 injected through the middle passage 22 is gradually increased. Further, switching between coal slurry mode and a standby mode, where the flow of coal slurry 40 is stopped and injection of the fuel flow 32 is resumed, can occur quickly since the nozzle tip 10 has the ability to inject either or both types of fuel via the separate center body 12 and middle passage 22.

In some embodiments, the inner tip end 26, the middle passage end 28, and/or the outer passage end 30 are flush with the distal end 18 of the center body 12. Having the ends all flush with each other prevents premixing of the fuels with the primary oxygen, which may be detrimental to performance of the gasifier. Further, the flush end configuration prevents burnback during coal slurry mode operation.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. An injector tip for a nozzle comprising:
a center body having a plurality of center body openings at a distal end configured to inject a fuel flow into a combustion zone of a combustor;
one or more fuel passages arranged around the center body configured to inject a fuel slurry into the combustion zone; and
one or more oxygen passages arranged around the center body to inject an oxygen flow into the combustion zone.

2. The injector tip of claim 1, wherein at least one of the one or more fuel passages or at least one of the one or more oxygen passages are substantially concentric with the center body.

3. The injector tip of claim 1, wherein at least one of the one or more fuel passages or at least one of the one or more oxygen passages are substantially flush with the distal end of the center body.

4. The injector tip of claim 1, wherein the center body is further configured to inject a purge fluid into the combustion zone.

5. The injector tip of claim 4, wherein the purge fluid is at least one of steam, water, nitrogen, or CO₂.

6. The injector tip of claim 5, wherein the purge fluid is recycled CO₂.

7. The injector tip of claim 1, wherein the one or more fuel passages are further configured to inject a fuel flow and/or a mixture of fuel flow and fuel slurry into the combustion zone.

8. The injector tip of claim 1, wherein the fuel flow comprises a low-sulfur, gaseous fuel.

9. The injector tip of claim 8, wherein the fuel flow comprises natural gas.

10. The injector tip of claim 1, wherein the fuel slurry comprises a high carbon fuel mixed with water.

11. The injector tip of claim 1, wherein the fuel slurry comprises a coal slurry.

12. The injector tip of claim 1, wherein the nozzle is a nozzle of a gasifier.

13. A method of fuel injection into a combustor comprising:
injecting a first portion of a fuel flow into a combustion zone of the combustor through a plurality of center body openings in a distal end of a center body of an injector tip;
injecting a second portion of the fuel flow into the combustion zone via one or more fuel passages arranged around the center body; and
suspending the injection of the second portion of the fuel flow; and
injecting a fuel slurry into the combustion zone via one or more fuel passages.

14. The method of claim 13, further comprising:
suspending the injection of the first portion of the fuel flow; and
injecting a fluid into the combustion zone via the plurality of center body openings.

15. The method of claim 13, wherein injecting the second portion of the fuel flow and injecting the fuel slurry comprise simultaneously injecting the second portion of the fuel flow and injecting the fuel slurry into the combustion zone via the one or more fuel passages.

16. The injector tip of claim 13, wherein the fuel slurry comprises a high carbon fuel mixed with water.

17. The method of claim 13, wherein injecting the fuel slurry comprises injecting a coal slurry.

18. The method of claim 13, wherein injecting the fuel flow comprises injecting at least one of a low-sulfur gaseous fuel or injecting natural gas.

19. The method of claim 13, wherein at least one of the one or more fuel passages are substantially concentric with the center body.

20. The method of claim 13, further comprising injecting a flow of oxygen into the combustion zone via one or more oxygen passages arranged around the center body.
